(19) United States
(12) Patent Application Publication
(10) Pub. No.: US 2026/0037549 A1
(43) Pub. Date: Feb. 5, 2026

(54) INFORMATION PROCESSING DEVICE, INFORMATION PROCESSING METHOD, AND COMPUTER PROGRAM PRODUCT

(71) Applicant: KABUSHIKI KAISHA TOSHIBA, Tokyo (JP)

(72) Inventor: Shigeru MAYA, Edogawa Tokyo (JP)

(73) Assignee: KABUSHIKI KAISHA TOSHIBA, Tokyo (JP)

(21) Appl. No.: 19/247,677

(22) Filed: Jun. 24, 2025

(30) Foreign Application Priority Data
Jul. 30, 2024 (JP) 2024-123245

(51) Int. Cl. G06F 16/28; G06F 16/22

(52) U.S. Cl. CPC G06F 16/288; G06F 16/2264

(57) ABSTRACT

An information processing device includes at least one hardware processor. The hardware processor is configured to divide an entire graph indicating a relationship between a plurality of elements into a plurality of partial graphs. The hardware processor is configured to set an objective function for learning a representation vector of a partial graph for each of the plurality of partial graphs. The hardware processor is configured to calculate n representation vectors by learning to optimize the objective function using each of n (n is an integer of 1 or more) setting values for each of the plurality of partial graphs.

### CROSS-REFERENCE TO RELATED APPLICATIONS

This application is based upon and claims the benefit of priority from Japanese Patent Application No. 2024-123245, filed on Jul. 30, 2024; the entire contents of which are incorporated herein by reference.

### FIELD

Embodiments described herein relate generally to an information processing device, an information processing method, and a computer program product.

### BACKGROUND

In recent years, with the progress of the Internet of Things (IoT), utilization of relational data indicating a relationship between data pieces is accelerated. Specific examples of the relational data include purchase data and entry data. The purchase data is data indicating which user has bought what product. The entry data is data indicating which company an individual in job seeking activities has applied to.

In addition, for example, for purchase data, a technology has been proposed in which a relationship between a user and a product is captured as a graph, representation vectors (also referred to as a hidden state or a distributed representation) of each user and each product are calculated based on an adjacency relationship on the graph, and the representation vectors are utilized for applications such as promotions. In such a technique, for example, as the number of users and the number of products increase, the size of the representation vector becomes enormous, and there is a case where the representation vector cannot be calculated due to constraints of calculation resources.

### BRIEF DESCRIPTION OF THE DRAWINGS

FIG. 1 is a block diagram illustrating an information processing device according to a first embodiment;

FIG. 2 is a diagram illustrating an example of relational data represented in the form of a relationship graph;

FIG. 3 is a flowchart illustrating a calculation process according to the first embodiment;

FIG. 4 is a diagram illustrating an example of a partial graph;

FIG. 5 is a block diagram illustrating an information processing device according to a second embodiment;

FIG. 6 is a diagram illustrating an example of the presence or absence of a branch of each pair obtained in the embodiment;

FIG. 7 is a flowchart illustrating a calculation process according to the second embodiment;

FIG. 8 is a block diagram illustrating an information processing device according to a third embodiment;

FIG. 9 is a flowchart illustrating a calculation process according to the third embodiment;

FIG. 10 is a diagram illustrating a display example of an evaluation index;

FIG. 11 is a block diagram illustrating an information processing device according to a fourth embodiment;

FIG. 12 is a diagram illustrating an example of a knowledge graph;

FIG. 13 is a block diagram illustrating an information processing device according to a fifth embodiment;

FIG. 14 is a diagram illustrating a display example of features; and

FIG. 15 is a diagram illustrating a hardware configuration of the information processing device according to the first to fifth embodiments.

### DETAILED DESCRIPTION

According to an embodiment, an information processing device includes at least one hardware processor. The hardware processor is configured to divide an entire graph indicating a relationship between a plurality of elements into a plurality of partial graphs. The hardware processor is configured to set an objective function for learning a representation vector of a partial graph for each of the plurality of partial graphs. The hardware processor is configured to calculate n representation vectors by learning to optimize the objective function using each of n setting values for each of the plurality of partial graphs, where n is an integer of 1 or more.

Hereinafter, a preferred embodiment of an information processing device according to the present disclosure is specifically described with reference to the accompanying drawings.

As described above, for example, the purchase data is expected to capture features of a user and a product and to be used for development, marketing, customer profiling, promotion, and the like of new products.

For example, by listing products having a representation vector similar to a representation vector (hidden state, distributed representation) of a certain user, it is possible to recommend products related to the user. In addition, by clustering the product and the representation vector of the user, users and products having the same purchase pattern can be clustered (classified), and the classification result can be used for marketing and the like.

In the case of purchase data, the representation vector is calculated by learning so as to capture the presence or absence of purchase as accurately as possible. The calculation of the representation vector is a technique that can be generally used in various tasks. Meanwhile, the purchase data often includes various products, and the number of target users becomes enormous.

The representation vector is calculated for each element such as a user and a product. When learning is performed so as to capture a relationship (for example, presence or absence of purchase) between a plurality of elements, for example, representation vectors of the plurality of elements included in the purchase data are collectively calculated. In such a case, the representation vector corresponding to the entire purchase data is a vector having a size corresponding to a value obtained by multiplying the number of elements and the number of dimensions of the representation vector.

For the calculation (learning) of the representation vector, a graphics processing unit (GPU), which is a calculation resource suitable for the calculation of the representation vector, may be used. In addition, a memory (GPU memory) used for calculation by the GPU may be smaller in size than a memory such as a random access memory (RAM) used for other calculations. For this reason, when the number of elements such as the number of users and the number of products is enormous, the size of the representation vector corresponding to the entire data becomes enormous, and thus the calculation of the representation vector cannot be executed due to constraints of calculation resources in some cases. In consideration of such a situation, it is required to more efficiently calculate a representation vector with higher accuracy.

It is also conceivable to divide a graph (entire graph) representing a relationship between a user and a product into a plurality of small partial graphs and learn a representation vector only for the user and the product belonging to each partial graph. However, in such a method, a relationship with a product or a user belonging to different partial graphs cannot be captured, and problems such as limitation on a range of products and users that can be utilized and a decrease in performance may occur.

Therefore, in the following embodiment, a target graph (entire graph) is divided into a plurality of small-scale partial graphs, an objective function suitable for each partial graph is set, and a representation vector is calculated for each partial graph using the objective function. The representation vector of the plurality of partial graphs can be, for example, a final representation vector of the entire graph by being connected.

Since the representation vector is calculated for each small-scale partial graph, it is possible to suppress incapability of the calculation of the representation vector due to constraints of calculation resources and to calculate the representation vector more efficiently. Note that the representation vector for each partial graph is, for example, a vector obtained by connecting representation vectors for the number of elements included in the partial graph.

### First Embodiment

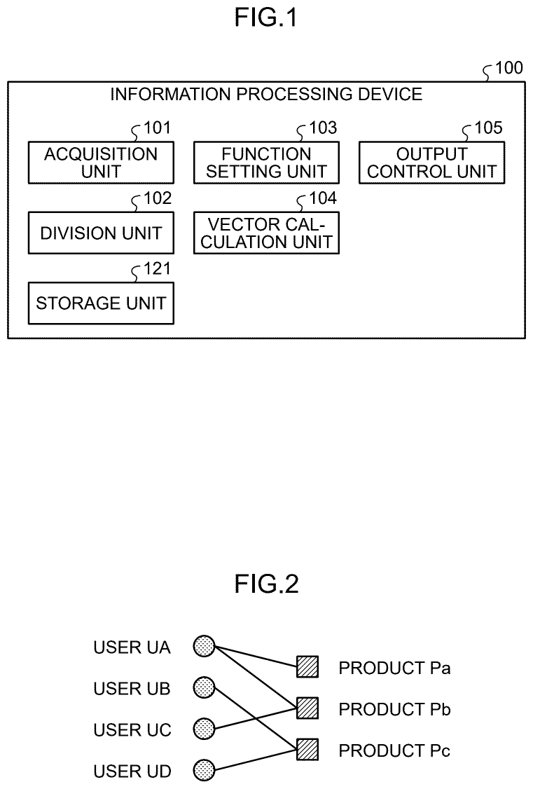

FIG. 1 is a block diagram illustrating an example of a configuration of an information processing device 100 according to a first embodiment. As illustrated in FIG. 1, the information processing device 100 includes a storage unit 121, an acquisition unit 101, a division unit 102, a function setting unit 103, a vector calculation unit 104, and an output control unit 105.

The storage unit 121 stores various types of information to be used in the information processing device 100. For example, the storage unit 121 stores relational data to be a target of calculation of a representation vector, a partial graph obtained by the division unit 102, and the like.

The relational data may be any type of data as long as the data indicates a relationship between a plurality of elements. An example of the relational data is described below.
Purchase data indicating a relationship between a product and a user: Elements are a product and a user.
Document data indicating a relationship between a word and a document: Elements are a word and a document.
Citation data indicating a citation relationship between documents: Elements are documents.
Entry data indicating which company an individual (user) has entered: Elements are a user and a company.
SNS data indicating who and who are connected by a social networking service (SNS) (connection of a plurality of users): Elements are users.

Hereinafter, an example of mainly using relational data related to purchase data is described. FIG. 2 is a diagram illustrating an example of relational data regarding purchase data. FIG. 2 illustrates an example of relational data represented in the form of a graph (relationship graph) illustrating a relationship between a plurality of users UA, UB, UC, and UD and a plurality of products Pa, Pb, and Pc. In the present embodiment, the relationship graph as illustrated in FIG. 2 corresponds to an entire graph to be a target of calculation of a representation vector.

The relational data may be preprocessed in advance. For example, in the case of relational data related to document data, processing of leaving only words having an appearance frequency equal to or more than a designated number of times as elements may be performed as the preprocessing. In the case of relational data related to the purchase data, a process of setting a branch between a user and a product having a relationship of having been purchased a designated number of times or more may be performed as the preprocessing. In the case of the relational data related to the citation data, the process of configuring the graph based only on the designated citation relationship of the data for the past several years may be performed as the preprocessing.

Note that, the storage unit 121 can be configured with any generally used storage medium such as a flash memory, a memory card, a random access memory (RAM), a hard disk drive (HDD), and an optical disc.

The acquisition unit 101 acquires various types of information to be used in the information processing device 100. For example, the acquisition unit 101 acquires relational data to be processed and stores the relational data in the storage unit 121. The acquisition unit 101 may acquire information used for processing of each unit such as the number of designated divisions (division number) and the number of dimensions of the designated representation vector.

A method of acquiring information by the acquisition unit 101 may be any method, and for example, a method of receiving information from an external device via a network, a method of reading information from a storage medium, or the like can be applied.

The division unit 102 divides the entire graph indicating the relational data into a plurality of partial graphs. The division unit 102 may divide the entire graph into a designated number (division number) of partial graphs. The division unit 102 stores the partial graph obtained by the division, for example, in the storage unit 121.

The function setting unit 103 sets an objective function for learning a representation vector of a partial graph for each of the plurality of partial graphs. For example, the function setting unit 103 sets an objective function including a function FA (first function) that outputs different values between a combination including two connected elements and a combination including two elements not connected among combinations of two elements included in the partial graph. The function setting unit 103 may set an objective function for obtaining a representation vector of the designated number of dimensions.

The vector calculation unit 104 calculates a representation vector by optimizing the value of the objective function. For example, the vector calculation unit 104 calculates n representation vectors by learning to optimize an objective function using each of n (n is an integer of 1 or more) setting values for each of the plurality of partial graphs. In the present embodiment, an example using one (n=1) setting value is described. An example in which n is 2 or more is described in a third embodiment.

The setting value may be any information, and is, for example, a hyperparameter that defines a learning method. For example, at the time of learning a representation vector of a certain element, information indicating up to how many hops ahead elements are to be considered among the elements connected to the element on the partial graph can be used as the setting value.

The output control unit 105 controls output of various types of information used in the information processing device 100. For example, the output control unit 105 outputs a representation vector calculated for each of the plurality of partial graphs. The output control unit 105 may output a representation vector obtained by connecting the representation vectors of the plurality of partial graphs as a final representation vector for the entire graph.

The information output method may be any method, and for example, a method of displaying information on a display device, a method of transmitting information to an external device via a network, and the like can be applied.

At least a part of each unit (the acquisition unit 101, the division unit 102, the function setting unit 103, the vector calculation unit 104, and the output control unit 105) may be implemented by one or more processors. Each of the above units is implemented by, for example, one or a plurality of processors. For example, each of the above units may be implemented by causing a processor such as a central processing unit (CPU) and a graphics processing unit (GPU) to execute a program, that is, by software. Each of the above units may be implemented by a processor such as a dedicated integrated circuit (IC), that is, by hardware. Each of the above units may be implemented by using software and hardware in combination. When plural processors are used, each processor may implement one of the units or may implement two or more of the units.

In addition, the information processing device 100 may be physically configured with one device or may be physically configured with a plurality of devices. For example, the information processing device 100 may be constructed on a cloud environment. Furthermore, each unit in the information processing device 100 may be dispersedly provided in a plurality of devices.

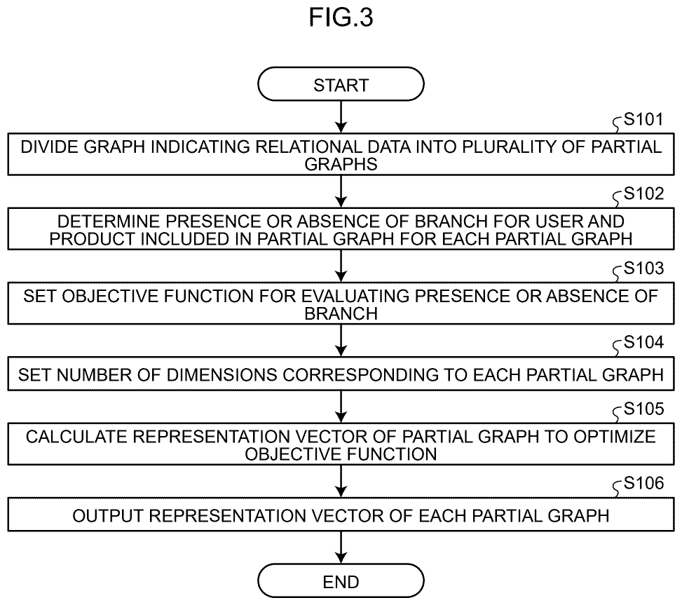

Next, a representation vector calculation process by the information processing device 100 according to the first embodiment is described. FIG. 3 is a flowchart illustrating an example of the calculation process according to the first embodiment.

The division unit 102 divides the entire graph indicating the relational data into a plurality of partial graphs (Step S101).

The function setting unit 103 determines the presence or absence of a branch for each pair of the user and the product included in the partial graph in the plurality of partial graphs obtained by the division (Step S102). For example, the function setting unit 103 extracts, from the target partial graph, the user and the product belonging to the partial graph and extracts, from the pair including the user and the product, a pair having a branch connecting the user and the product included in the pair and a pair having no branch.

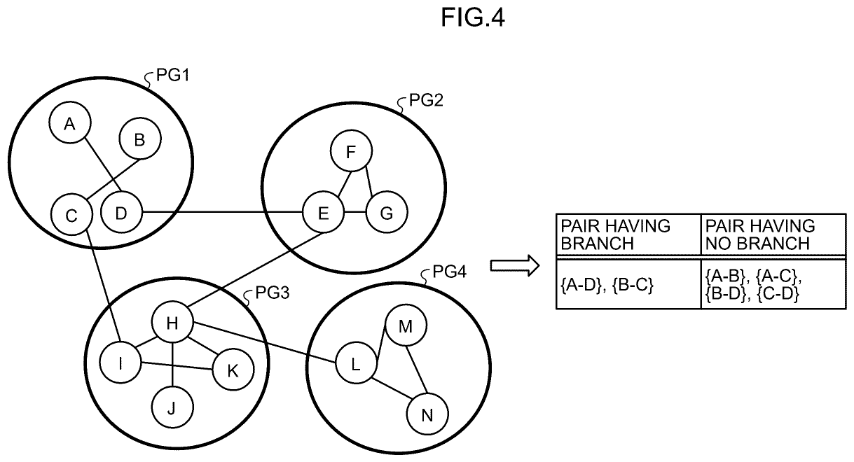

FIG. 4 is a diagram illustrating an example of a partial graph obtained by division and a pair in the partial graph. FIG. 4 is an example of four partial graphs PG1 to PG4. Elements A to N correspond to either the user or the product. The elements at both ends of each branch are users and products. For example, for the partial graph PG1, pairs having branches are {A-D} and {B-C}, and pairs having no branches are {A-B}, {A-C}, {B-D}, and {C-D}. Similarly, presence or absence of a branch of each pair is determined for the other partial graphs.

The description returns to FIG. 3. The function setting unit 103 sets an objective function for learning a representation vector for each of the plurality of partial graphs (Step S103). For example, the function setting unit 103 sets an objective function for evaluating the presence or absence of a branch for a pair included in the partial graph. For example, the objective function sets an objective function in which a pair having a branch outputs a larger evaluation value than a pair having no branch. Such an objective function may be any function, and is, for example, an objective function using logistic regression and Bayesian Personalized Ranking (BPR) loss.

The vector calculation unit 104 learns the representation vector so as to optimize the objective function obtained by the function setting unit 103. First, the vector calculation unit 104 sets the number of dimensions for the representation vector corresponding to each partial graph (Step S104).

For example, the vector calculation unit 104 sets the number of dimensions acquired by the acquisition unit 101 as the number of dimensions of the representation vector. The vector calculation unit 104 may determine the number of dimensions of the representation vector based on the feature of the partial graph for each of the plurality of partial graphs. The features of the partial graph are, for example, the number of elements included in the partial graph and the number of branches connecting the elements included in the partial graph. For example, the vector calculation unit 104 may determine a value obtained by multiplying the number of branches in each partial graph by a predetermined proportional constant and then rounding the result to an integer value as the number of dimensions of the representation vector. The vector calculation unit 104 may determine the number of dimensions for the representation vector according to the size of a storage device (for example, a GPU memory) that stores the partial graph.

Next, the vector calculation unit 104 calculates the representation vector of the partial graph by learning the representation vector of the partial graph so as to optimize the objective function (Step S105). The learning method may be any conventionally used method, and for example, the following method can be applied.
Method using matrix decomposition
Method using graph analysis techniques such as graph neural networks

The output control unit 105 outputs the calculated representation vector of each partial graph (Step S106) and ends the calculation process. The output control unit 105 may generate and output a representation vector of the entire graph by combining the calculated representation vectors of the partial graphs.

As described above, in the information processing device according to the first embodiment, the representation vector is calculated for each of the plurality of partial graphs obtained by dividing the entire graph. As a result, the representation vector can be more efficiently calculated.

### Second Embodiment

In the first embodiment, for each partial graph, the representation vector is learned so as to capture the relationship between the presence or absence of the branch in the partial graph. Meanwhile, there are many other partial graphs in the entire graph. Therefore, it is considered that the accuracy of the representation vector can be further improved by incorporating the structure of the branch other than the partial graph to be learned. In the second embodiment, an objective function considering the presence or absence of a branch of a pair with an element of another partial graph and the presence or absence of a branch of a pair in the entire graph is used.

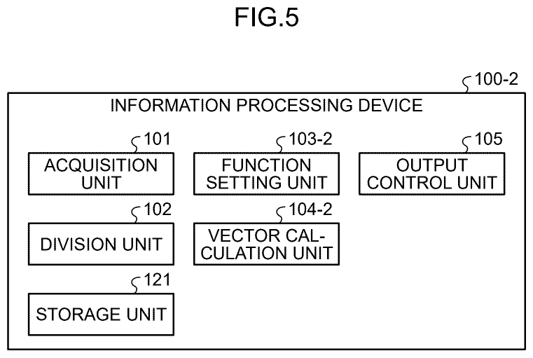

FIG. 5 is a block diagram illustrating an example of a configuration of an information processing device 100-2 according to the second embodiment. As illustrated in FIG. 5, the information processing device 100-2 includes the storage unit 121, the acquisition unit 101, the division unit 102, a function setting unit 103-2, a vector calculation unit 104-2, and the output control unit 105.

In the second embodiment, functions of the function setting unit 103-2 and the vector calculation unit 104-2 are different from those of the first embodiment. Other configurations and functions are similar to those in FIG. 1 which is the block diagram of the information processing device 100 according to the first embodiment and thus are denoted by the same reference numerals, and description thereof here is omitted.

The function setting unit 103-2 is different from the function setting unit 103 of the first embodiment in that an objective function further including at least one of a function FB (second function) and a function FC (third function) described below is set in addition to the function FA.
Function FB: Function that outputs different values between a case where an element included in a partial graph (hereinafter, a target graph) that is a setting target of an objective function and an element included in one or more partial graphs (hereinafter, non-target graphs) other than the target graph are connected to each other and a case where the elements are not connected to each other
Function FC: Function that outputs different values between a combination including two connected elements and a combination including two elements not connected among combinations of two elements included in the entire graph

For the function FB and the function FC, the function setting unit 103-2 determines the presence or absence of the branch of each pair focused on between the partial graphs and determines the presence or absence of the branch of each pair focused on the entire graph. For example, the function setting unit 103-2 extracts a pair having a branch connecting two elements included in the pair and a pair having no branch from pairs of elements (user, product) included in the target graph and an element included in the non-target graph. In addition, the function setting unit 103-2 extracts a pair having a branch connecting two elements included in the pair and a pair having no branch from the pair of elements included in the entire graph.

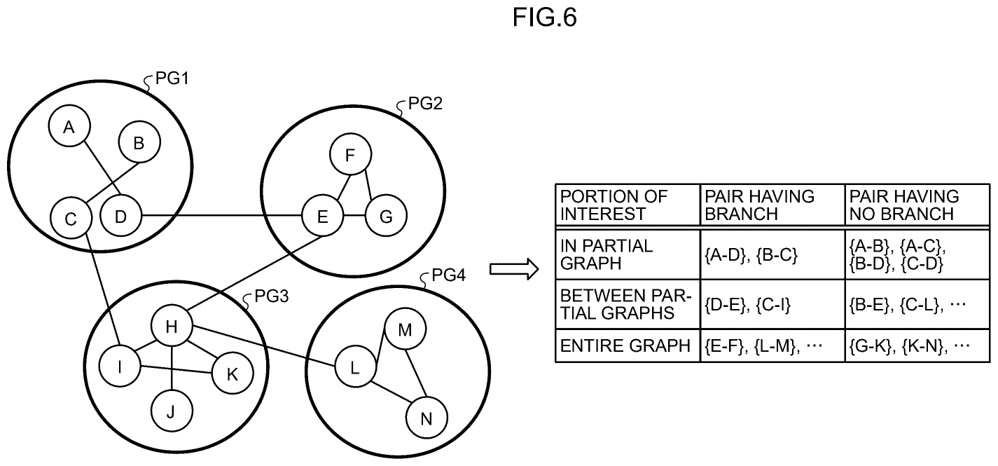

FIG. 6 is a diagram illustrating an example of the presence or absence of a branch of each pair obtained in the present embodiment. FIG. 6 is an example of the presence or absence of a branch of each pair obtained from the four partial graphs PG1 to PG4 similar to FIG. 4 of the first embodiment.

In a case where the partial graph PG1 is the target graph, and attention is paid between the partial graphs, for example, a pair {D-E} of the element D included in the partial graph PG1 and the element E included in the partial graph PG2 and a pair {C-I} of the element C included in the partial graph PG1 and the element I included in the partial graph PG3 are extracted as pairs having branches.

In a case where the partial graph PG1 is a target graph, and attention is paid to the entire graph, for example, a pair {E-F} of elements in the partial graph PG2 that is a non-target graph, and the like are extracted as pairs having branches.

The description returns to FIG. 5. The vector calculation unit 104-2 calculates the representation vector by optimizing the value of the objective function including the function FA and at least one of the function FB and the function FC.

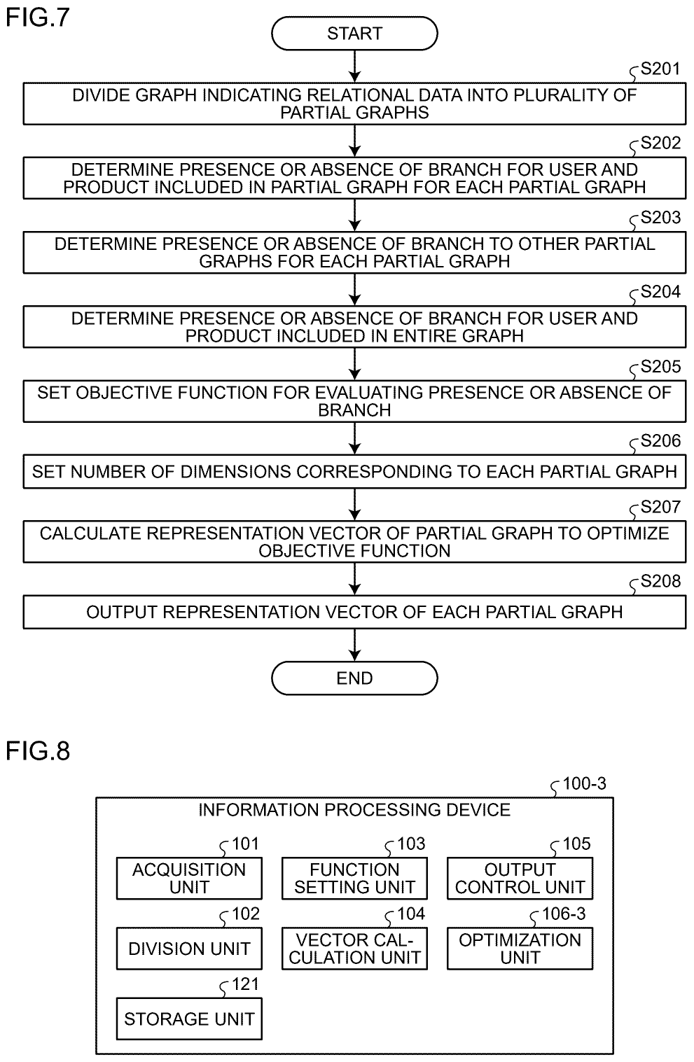

Next, the calculation process by the information processing device 100-2 according to the second embodiment is described with reference to FIG. 7. FIG. 7 is a flowchart illustrating an example of the calculation process according to the second embodiment.

Since Steps S201 to S202 are similar to Steps S101 to S102 of the information processing device 100 of the first embodiment, the description thereof is omitted.

In the present embodiment, the function setting unit 103-2 determines the presence or absence of a branch for another partial graph (non-target graph) for each partial graph (target graph) (Step S203). In addition, the function setting unit 103-2 determines the presence or absence of a branch for the user and the product included in the entire graph (Step S204). As a result, for example, a determination result of the presence or absence of the branch of each pair as illustrated in FIG. 6 can be obtained.

The function setting unit 103-2 sets an objective function including the function FA and at least one of the function FB and the function FC according to the obtained determination result of the presence or absence of the branch (i.e., the function setting unit 103-2 sets an objective function for evaluating the presence or absence of the branch) (Step S205). Similar to the first embodiment, the objective function is, for example, an objective function in which a pair having a branch outputs a larger evaluation value than a pair having no branch.

The objective function may be set by weighted addition of the three functions FA, FB, and FC. For example, the function setting unit 103-2 may set an objective function represented by the following Formula (1). α, β, and γ represent weights. One of β and γ may be set to 0.

$$Objective Function = α \times Function FA + β \times Function FB + γ \times Function FC \qquad ( 1 )$$

Since Steps S206 to S208 are similar to Steps S104 to S106 of the information processing device 100 of the first embodiment, the description thereof is omitted.

As described above, the information processing device according to the second embodiment learns the representation vector of the target graph in consideration of not only the pair of elements in the target partial graph (target graph) but also the pair with the element of another partial graph (non-target graph) and the pair in the entire graph. As a result, for example, it is possible to calculate a representation vector capturing a relationship with products or users belonging to different partial graphs. As a result, the accuracy of the process using the representation vector can be further improved.

### Third Embodiment

The information processing device according to the third embodiment calculates a plurality of representation vectors using a plurality of setting values (n≥2) for each partial graph and appropriately combines the plurality of representation vectors to obtain an optimum representation vector. As a result, the quality of the representation vector can be improved.

FIG. 8 is a block diagram illustrating an example of a configuration of an information processing device 100-3 according to the third embodiment. As illustrated in FIG. 8, the information processing device 100-3 includes the storage unit 121, the acquisition unit 101, the division unit 102, the function setting unit 103, the vector calculation unit 104, the output control unit 105, and an optimization unit 106-3.

The third embodiment is different from the first embodiment in that the optimization unit 106-3 is added. Other configurations and functions are similar to those in FIG. 1 which is the block diagram of the information processing device 100 according to the first embodiment and thus are denoted by the same reference numerals, and description thereof here is omitted.

Note that, in the present embodiment, the vector calculation unit 104 calculates n representation vectors by learning to optimize an objective function using each of n (n≥2) setting values for each of the plurality of partial graphs.

The optimization unit 106-3 performs a process of obtaining an optimum representation vector from the n representation vectors. For example, the optimization unit 106-3 obtains a combination having an evaluation index larger than that of another combination among the combinations of n representation vectors calculated for each of the plurality of partial graphs.

The overall flow of the representation vector calculation process of the present embodiment is similar to the calculation process (FIG. 3) of the first embodiment. After the representation vector of each partial graph is obtained in Step S106, the process by the optimization unit 106-3 is performed when the representation vector of the entire graph is obtained.

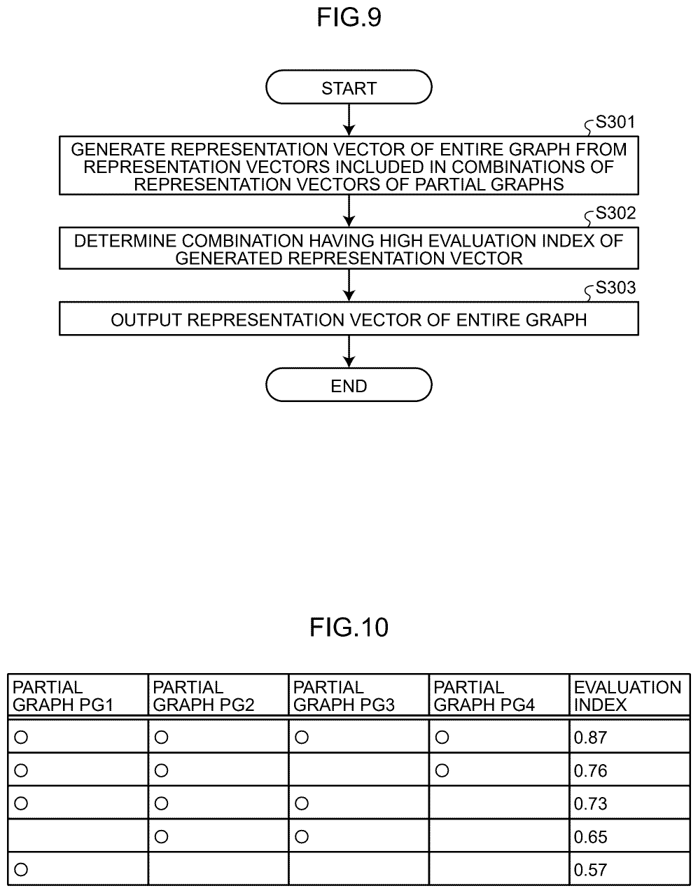

The optimization process by the optimization unit 106-3 is described with reference to FIG. 9. FIG. 9 is a flowchart illustrating an example of the calculation process according to the third embodiment.

The optimization unit 106-3 generates a representation vector of the entire graph from the representation vectors included in the combinations of the representation vectors of the partial graphs (Step S301). A designated number (for example, one) of representation vectors is selected from the n representation vectors of each partial graph. Hereinafter, a case where one representation vector is selected from each partial graph is described as an example.

The optimization unit 106-3 generates a final representation vector for the entire graph from a plurality of representation vectors included in the obtained combination. For example, the optimization unit 106-3 generates a final representation vector by connecting a plurality of representation vectors included in the combination.

For example, a case where the number of partial graphs is four, and five (n=5) 20-dimensional representation vectors are calculated for every 4 partial graphs by the vector calculation unit 104 is considered. In this case, the number of combinations of the representation vectors is 5×5×5×5=625. The optimization unit 106-3 generates a final representation vector of 20×4=80 dimensions by connecting the four 20-dimensional representation vectors included in the combination.

The method of generating the representation vector of the entire graph is not limited to the above. The optimization unit 106-3 may use any one of the following generation methods.
Weighted average value of a plurality of representation vectors included in combination
Connection of a plurality of conversion vectors obtained by converting each of a plurality of representation vectors included in a combination
Weighted average value of a plurality of conversion vectors for each of plurality of representation vectors included in combination

When the weighted average value is used, the number of dimensions of the representation vector of the entire graph is the same as the number of dimensions of the representation vector of the partial graph. The conversion of the representation vector may be performed by any method and can be implemented, for example, by a method using deep learning.

The optimization unit 106-3 calculates an evaluation index of the generated representation vector and obtains a combination corresponding to the representation vector having an evaluation index larger than those of other combinations (i.e. the optimization unit 106-3 determines a combination having a high evaluation index of the generated representation vector; for example, the evaluation index is maximum) (Step S302).

The evaluation index may be any index, and a performance index used in product recommendation such as Recall and an area under the ROC curve (AUC) may be used. A process of searching for an optimum combination of evaluation indexes may be a search process by brute-force or may be a search process of utilizing a mathematical optimization method such as Bayesian optimization.

The optimization unit 106-3 outputs the representation vector of the entire graph corresponding to the obtained combination (Step S303) and ends the optimization process.

A function of outputting evaluation indexes for various combinations may be further provided. For example, the output control unit 105 may display the evaluation indexes calculated for a plurality of combinations in a list form on a display device or the like. FIG. 10 is a diagram illustrating a display example of an evaluation index. As illustrated in FIG. 10, the evaluation index may be calculated for a combination in which a representation vector is selected from some of the plurality of partial graphs.

As described above, in the information processing device according to the third embodiment, an optimum representation vector can be obtained by combining a plurality of representation vectors calculated for each partial graph. As a result, a higher-quality representation vector can be more efficiently calculated.

### Fourth Embodiment

The information processing device according to the fourth embodiment further improves the quality of the representation vector to be calculated by using the knowledge regarding the elements of the graph.

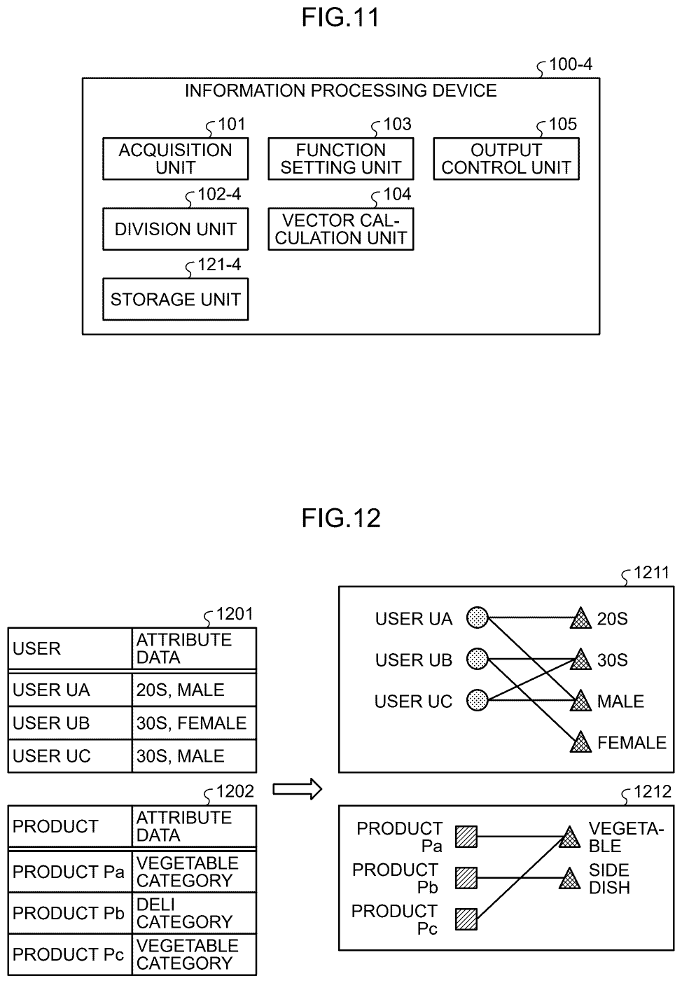

FIG. 11 is a block diagram illustrating an example of a configuration of an information processing device 100-4 according to the fourth embodiment. As illustrated in FIG. 11, the information processing device 100-4 includes a storage unit 121-4, the acquisition unit 101, a division unit 102-4, the function setting unit 103, the vector calculation unit 104, and the output control unit 105.

In the fourth embodiment, functions of the storage unit 121-4 and the division unit 102-4 are different from those of the first embodiment. Other configurations and functions are similar to those in FIG. 1 which is the block diagram of the information processing device 100 according to the first embodiment and thus are denoted by the same reference numerals, and description thereof here is omitted.

The storage unit 121-4 is different from the storage unit 121 of the first embodiment in that a knowledge graph indicating knowledge regarding elements is further stored. FIG. 12 is a diagram illustrating an example of a knowledge graph.

FIG. 12 illustrates an example of a knowledge graph 1211 which is a graph representing a knowledge 1201 regarding the user and a knowledge graph 1212 which is a graph representing a knowledge 1202 regarding the product. The knowledge 1201 includes attribute data of the user, which is one of the elements of the purchase data, as the knowledge. The attribute data of the user is, for example, an age and a gender. The knowledge 1202 includes attribute data of the product, which is one of the elements of the purchase data, as the knowledge. The attribute data of the product is, for example, category information of the product (e.g. vegetable category, deli category).

The division unit 102-4 performs graph division for an entire graph obtained by combining a relationship graph indicating a relationship between a plurality of elements and a knowledge graph. The entire graph may be generated in advance and stored in the storage unit 121-4. The division unit 102-4 may generate the entire graph by combining the relationship graph and the knowledge graph.

By targeting the entire graph obtained by combining the knowledge graphs, for example, elements having the same or similar attributes (users of the same age group, products of the same category, and the like) are likely to belong to the same partial graph. As a result, it is possible to create a partial graph according to the user and the taste of the product.

As described above, the information processing device according to the fourth embodiment further improves the quality of the representation vector to be calculated by using the knowledge regarding the elements of the graph.

### Fifth Embodiment

The information processing device according to the fifth embodiment further includes a function of utilizing the calculated representation vector. For example, a utilization method in a case where the representation vector is obtained for each user and each product includes recommendation of a product to the user (product recommendation) and marketing.

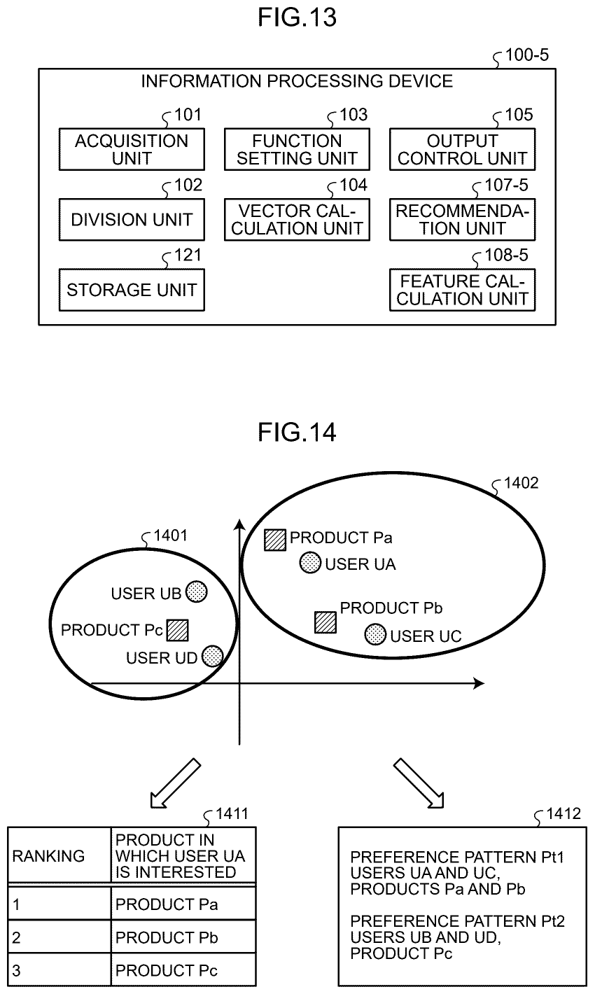

FIG. 13 is a block diagram illustrating an example of a configuration of an information processing device 100-5 according to the fifth embodiment. As illustrated in FIG. 13, the information processing device 100-5 includes the storage unit 121, the acquisition unit 101, the division unit 102, the function setting unit 103, the vector calculation unit 104, the output control unit 105, a recommendation unit 107-5, and a feature calculation unit 108-5.

The fifth embodiment is different from the first embodiment in that the recommendation unit 107-5 and the feature calculation unit 108-5 are added. Other configurations and functions are similar to those in FIG. 1 which is the block diagram of the information processing device 100 according to the first embodiment and thus are denoted by the same reference numerals, and description thereof here is omitted.

The recommendation unit 107-5 is a function for performing product recommendation. For example, the recommendation unit 107-5 obtains a representation vector similar to the representation vector of the entire graph calculated by the function similar to that of the above-described embodiment among the representation vectors of the plurality of elements, and outputs an element corresponding to the obtained representation vector as an element to be recommended.

For example, the recommendation unit 107-5 may recommend a product having a representation vector similar to the representation vector of the target user. The similarity between the representation vectors may be calculated by any method, and a method using an inner product or a cosine similarity can be applied. In a case where a product to be recommended has already been determined, and to which user the product should be recommended is to be obtained, the recommendation unit 107-5 may recommend a user having a representation vector similar to the representation vector of the product.

The recommendation unit 107-5 may obtain a ranking (order) according to the similarity. In this case, for example, the output control unit 105 may output information (recommendation information) in which a product to be recommended is associated with the ranking.

The feature calculation unit 108-5 is a function for calculating features available for marketing. For example, the feature calculation unit 108-5 obtains features of a plurality of elements by using a representation vector of an entire graph calculated by a function similar to that of the above-described embodiment and outputs the obtained features.

The feature may be calculated by any method, but for example, a method of clustering the representation vectors and calculating the feature for each cluster can be applied. For example, the feature calculation unit 108-5 performs clustering on the calculated representation vector for each element to obtain a plurality of clusters. The feature calculation unit 108-5 calculates a feature for each cluster. The feature of the cluster is calculated, for example, by analyzing an element corresponding to a representation vector included in the cluster. For example, when the element is a product, it is possible to obtain a feature that the product is a product with a large amount of salt by referring to the product name and other information related to the product. Furthermore, when the element is the user, a preference pattern or the like of the user can be obtained as the feature of the user from the products classified into the same cluster as the user.

The output control unit 105 may output information (feature information) indicating the obtained feature. FIG. 14 is a diagram illustrating a display example of a feature. FIG. 14 is an example of a representation vector calculated for purchase data and recommendation information and feature information obtained from the representation vector.

The upper graph of FIG. 14 represents an example of a representation vector simplified in two dimensions for convenience of description. Clusters 1401 and 1402 are examples of clusters obtained by clustering the representation vectors.

Recommendation information 1411 is, for example, an example of recommendation information obtained by the recommendation unit 107-5. For example, for the user UA, high ranking is associated with the products Pa and Pb classified into the same cluster 1402.

Feature information 1412 is, for example, an example of feature information calculated by the feature calculation unit 108-5. A preference pattern Pt1 is an example of a feature obtained for the cluster 1402. A preference pattern Pt2 is an example of a feature obtained for the cluster 1401.

As described above, in the information processing device according to the fifth embodiment, the representation vector can be used for product recommendation, marketing, and the like.

As described above, according to the first to fifth embodiments, the representation vector can be more efficiently calculated.

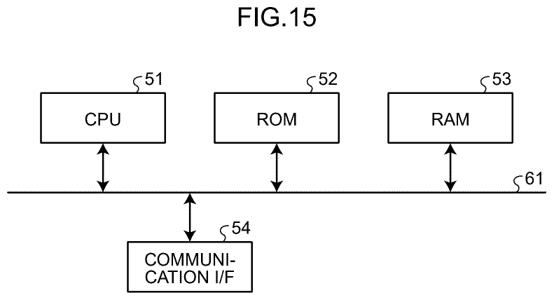

Next, a hardware configuration of the information processing device according to the first to fifth embodiments is described with reference to FIG. 15. FIG. 15 is an explanatory diagram illustrating a hardware configuration example of the information processing device according to the first to fifth embodiments.

The information processing device according to the first to fifth embodiments includes a control device such as a central processing unit (CPU) 51, a storage device such as a read only memory (ROM) 52 and a random access memory (RAM) 53, a communication I/F 54 that is connected to a network and performs communication, and a bus 61 that connects the respective units.

The program executed by the information processing device according to the first to fifth embodiments is provided by being incorporated in the ROM 52 or the like in advance.

The program executed by the information processing device according to the first to fifth embodiments may be configured to be provided as a computer program product by being recorded as a file in an installable format or an executable format in a computer-readable recording medium such as a compact disk read only memory (CD-ROM), a flexible disk (FD), a compact disk recordable (CD-R), or a digital versatile disk (DVD).

Furthermore, the program executed by the information processing device according to the first to fifth embodiments may be configured to be stored on a computer connected to a network such as the Internet and provided by being downloaded via the network. In addition, the program executed by the information processing device according to the first to fifth embodiments may be configured to be provided or distributed via a network such as the Internet.

The program executed by the information processing device according to the first to fifth embodiments can cause the computer to function as each unit of the information processing device described above. In this computer, the CPU 51 can read the program from a computer-readable storage medium onto a main storage device and execute the program.

A configuration example of the embodiments is described below.

Configuration Example 1. According to an embodiment, an information processing device includes at least one hardware processor. The hardware processor is configured to divide an entire graph indicating a relationship between a plurality of elements into a plurality of partial graphs. The hardware processor is configured to set an objective function for learning a representation vector of a partial graph for each of the plurality of partial graphs. The hardware processor is configured to calculate n representation vectors by learning to optimize the objective function using each of n setting values for each of the plurality of partial graphs, where n is an integer of 1 or more.

Configuration Example 2. In the information processing device according to example 1, the objective function includes a first function that outputs different values between a combination including two elements to be connected and a combination including two elements not to be connected among combinations of two elements included in the partial graph.

Configuration Example 3. In the information processing device according to example 2, the objective function further includes a second function that outputs different values between a case where an element included in a target graph indicating the partial graph that is a setting target of the objective function and an element included in a non-target graph indicating one or more partial graphs other than the target graph among the plurality of partial graphs are connected to each other and a case where the element included in the target graph and the element included in the non-target graph are not connected to each other.

Configuration Example 4. In the information processing device according to example 2, the objective function further includes a third function that outputs different values between a combination including two connected elements and a combination including two elements not connected among combinations of two elements included in the entire graph.

Configuration Example 5. In the information processing device according to example 2, the objective function further includes a second function and a third function. The second function outputs different values between a case where a target graph indicating the partial graph that is a setting target of the objective function and a non-target graph indicating one or more partial graphs other than the target graph among the plurality of partial graphs are connected to each other and a case where the target graph and the non-target graph are not connected to each other. The third function outputs different values between a combination including two connected elements and a combination including two elements not connected among combinations of two elements included in the entire graph.

Configuration Example 6. In the information processing device according to example 1, the hardware processor is configured to obtain a combination having an evaluation index larger than that of another combination among combinations of n representation vectors calculated for each of the plurality of partial graphs.

Configuration Example 7. In the information processing device according to example 6, among the combinations of the n representation vectors, the hardware processor is configured to obtain a combination of which an evaluation index of the representation vector of the entire graph calculated by any one of (i) connection of a plurality of representation vectors included in the combination, (ii) calculation of a weighted average value of the plurality of representation vectors included in the combination, (iii) connection of a plurality of conversion vectors obtained by converting each of the plurality of representation vectors included in the combination, and (iv) calculation of a weighted average value of the plurality of conversion vectors is larger than those of other combinations.

Configuration Example 8. In the information processing device according to example 6, the hardware processor is configured to obtain a combination of which the evaluation index is larger than those of other combinations using Bayesian optimization.

Configuration Example 9. In the information processing device according to example 1, the hardware processor is configured to determine, for each of the plurality of partial graphs, a number of dimensions of the representation vector based on a feature of the partial graph including a number of elements included in the partial graph and a number of branches connecting the elements included in the partial graph.

Configuration Example 10. In the information processing device according to example 1, the hardware processor is configured to determine a number of dimensions of the representation vector according to a size of a storage device that stores the partial graph therein.

Configuration Example 11. In the information processing device according to example 1, the entire graph is a graph obtained by combining a relationship graph indicating the relationship between the plurality of elements and a knowledge graph indicating knowledge on the plurality of elements.

Configuration Example 12. In the information processing device according to example 1, the hardware processor is configured to output an evaluation index for each combination of n representation vectors calculated for each of the plurality of partial graphs.

Configuration Example 13. In the information processing device according to example 1, the hardware processor is configured to obtain a representation vector similar to the representation vector of the entire graph calculated based on the representation vector for each of the plurality of partial graphs among the representation vectors of the plurality of elements and outputs an element corresponding to the obtained representation vector.

Configuration Example 14. In the information processing device according to example 1, the hardware processor is configured to obtain features of the plurality of elements by using a representation vector of the entire graph calculated based on the representation vector for each of the plurality of partial graphs.

Configuration Example 15. According to an embodiment, an information processing method is implemented by a computer of an information processing device. The method includes dividing an entire graph indicating a relationship between a plurality of elements into a plurality of partial graphs; setting an objective function for learning a representation vector of a partial graph for each of the plurality of partial graphs; and calculating n representation vectors by learning to optimize the objective function using each of n setting values for each of the plurality of partial graphs, where n is an integer of 1 or more.

Configuration Example 16. According to an embodiment, a computer program product has a non-transitory computer readable medium including programmed instructions stored thereon. When executed by a computer, the instructions cause the computer to execute dividing an entire graph indicating a relationship between a plurality of elements into a plurality of partial graphs; setting an objective function for learning a representation vector of a partial graph for each of the plurality of partial graphs; and calculating n representation vectors by learning to optimize the objective function using each of n setting values for each of the plurality of partial graphs, where n is an integer of 1 or more.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising
one or more hardware processors configured to:
divide an entire graph indicating a relationship between a plurality of elements into a plurality of partial graphs,
set an objective function for learning a representation vector of a partial graph for each of the plurality of partial graphs, and
calculate n representation vectors by learning to optimize the objective function using each of n setting values for each of the plurality of partial graphs, n being an integer of 1 or more.

2. The information processing device according to claim 1, wherein
the objective function includes a first function that outputs different values between a combination including two elements to be connected and a combination including two elements not to be connected among combinations of two elements included in the partial graph.

3. The information processing device according to claim 2, wherein
the objective function further includes a second function that outputs different values between a case where an element included in a target graph indicating the partial graph that is a setting target of the objective function and an element included in a non-target graph indicating one or more partial graphs other than the target graph among the plurality of partial graphs are connected to each other and a case where the element included in the target graph and the element included in the non-target graph are not connected to each other.

4. The information processing device according to claim 2, wherein
the objective function further includes a third function that outputs different values between a combination including two connected elements and a combination including two elements not connected among combinations of two elements included in the entire graph.

5. The information processing device according to claim 2, wherein the objective function further includes
a second function that outputs different values between a case where a target graph indicating the partial graph that is a setting target of the objective function and a non-target graph indicating one or more partial graphs other than the target graph among the plurality of partial graphs are connected to each other and a case where the target graph and the non-target graph are not connected to each other, and
a third function that outputs different values between a combination including two connected elements and a combination including two elements not connected among combinations of two elements included in the entire graph.

6. The information processing device according to claim 1, wherein
the one or more hardware processors obtain a combination having an evaluation index larger than that of another combination among combinations of n representation vectors calculated for each of the plurality of partial graphs.

7. The information processing device according to claim 6, wherein,
among the combinations of the n representation vectors,
the one or more hardware processors obtain a combination of which an evaluation index of the representation vector of the entire graph calculated by any one of
connection of a plurality of representation vectors included in the combination,
calculation of a weighted average value of the plurality of representation vectors included in the combination,
connection of a plurality of conversion vectors obtained by converting each of the plurality of representation vectors included in the combination, and
calculation of a weighted average value of the plurality of conversion vectors
is larger than those of other combinations.

8. The information processing device according to claim 6, wherein
the one or more hardware processors obtain a combination of which the evaluation index is larger than those of other combinations using Bayesian optimization.

9. The information processing device according to claim 1, wherein
the one or more hardware processors determine, for each of the plurality of partial graphs, a number of dimensions of the representation vector based on a feature of the partial graph including a number of elements included in the partial graph and a number of branches connecting the elements included in the partial graph.

10. The information processing device according to claim 1, wherein
the one or more hardware processors determine a number of dimensions of the representation vector according to a size of a storage device that stores the partial graph therein.

11. The information processing device according to claim 1, wherein
the entire graph is a graph obtained by combining a relationship graph indicating the relationship between the plurality of elements and a knowledge graph indicating knowledge on the plurality of elements.

12. The information processing device according to claim 1, wherein
the one or more hardware processors output an evaluation index for each combination of n representation vectors calculated for each of the plurality of partial graphs.

13. The information processing device according to claim 1, wherein
the one or more hardware processors obtain a representation vector similar to the representation vector of the entire graph calculated based on the representation vector for each of the plurality of partial graphs among the representation vectors of the plurality of elements and outputs an element corresponding to the obtained representation vector.

14. The information processing device according to claim 1, wherein
the one or more hardware processors obtain features of the plurality of elements by using a representation vector of the entire graph calculated based on the representation vector for each of the plurality of partial graphs.

15. An information processing method implemented by a computer of an information processing device, the method comprising:
dividing an entire graph indicating a relationship between a plurality of elements into a plurality of partial graphs;
setting an objective function for learning a representation vector of a partial graph for each of the plurality of partial graphs; and
calculating n representation vectors by learning to optimize the objective function using each of n setting values for each of the plurality of partial graphs, n being an integer of 1 or more.

16. A computer program product having a non-transitory computer readable medium including programmed instructions stored thereon, wherein the instructions, when executed by a computer, cause the computer to execute:
dividing an entire graph indicating a relationship between a plurality of elements into a plurality of partial graphs;
setting an objective function for learning a representation vector of a partial graph for each of the plurality of partial graphs; and
calculating n representation vectors by learning to optimize the objective function using each of n setting values for each of the plurality of partial graphs, n being an integer of 1 or more.
